(19) United States
(12) Patent Application Publication
(10) Pub. No.: US 2013/0173492 A1
(43) Pub. Date: Jul. 4, 2013

(54) COLLECTION AND DISTRIBUTION OF AFTER PURCHASE EXPERIENCE DATA

(71) Applicants: Matthew R. Leavenworth, Charlotte, NC (US); David M. Grigg, Rock Hill, SC (US)

(72) Inventors: Matthew R. Leavenworth, Charlotte, NC (US); David M. Grigg, Rock Hill, SC (US)

(73) Assignee: BANK OF AMERICA CORPORATION, Charlotte, NC (US)

(21) Appl. No.: 13/342,075

(22) Filed: Jan. 1, 2012

(51) Int. Cl. G06Q 30/00

(52) U.S. Cl. 705/347

(57) ABSTRACT

Embodiments of the invention are directed to a system, method, or computer program product for collecting and distributing after purchase experience data. Customers that have communicated with a merchant may provide more beneficial feedback to the merchants than other individuals. In this way, the system provides mechanisms for the customer to provide feedback if they have communicated with the merchant. Embodiments of the invention allow a customer to provide this feedback for a merchant, a product, or the total purchase experience of a customer. A system then compiles and sorts the data. In turn, a customer, a merchant, or other entities may be able to view the compiled after purchase experience data.

### BACKGROUND

Many factors may play a role in an individual's selection of a particular product. The individual's perception of the merchant, customer service provided by the merchant, the overall experience at the merchant, merchant recommendations, merchant reviews, past use of a product, advertisement of a product, offers for discounts for a product, product recommendations, product reviews etc. may all have a direct correlation with which products an individual may select to purchase and where that individual purchases the product.

Reviews and recommendations for products and/or merchants may originate from many sources, including, websites on the Internet, newspapers, social networking sites, etc. Reviews and recommendations may be in the form of comments, ratings, etc. from other individuals. Websites that provide reviews and recommendations may include only reviews and recommendations or the websites may include reviews along with the ability to purchase the products.

Many individuals select a particular product based on reviews or recommendations of the product. For example, if an individual is shopping online for a small kitchen appliance, the individual may look to the reviews posted online as guidance to select the appropriate brand or model of small kitchen appliance. These reviews or recommendations may persuade an individual to purchase a product. However, in some instances, these reviews or recommendations may not provide an accurate review of the product. In this way, the review provider may not have ever purchase or used the product, the review provider may work for the entity that manufactures or that provides the product. For example, the individuals providing reviews to a website may actually work for or sell a specific brand of small kitchen appliances, and therefore, reviews from that reviewer may not be an accurate depiction of the appliance. Furthermore, these reviews and recommendations are typically directed to the products themselves and not necessarily the merchant. Therefore, the individual purchasing the small kitchen appliance online may not be sure of the quality of the online merchant from which he/she is purchasing the appliance.

Therefore, a need exists for reviews and recommendations that are from individuals that have actually purchased the product or purchased products from the merchant that is being reviewed. In this way, the review may be a more accurate representation of the product or the merchant.

### BRIEF SUMMARY

Embodiments of the present invention address the above needs and/or achieve other advantages by providing apparatuses (e.g., a system, computer program product and/or other devices) and methods for providing merchants and individuals with after purchase experience data, thus providing merchants and customers with rich data. Rich data includes information from a customer that actually communicated with a merchant, independent of if a purchase is made.

In some embodiments, a customer may opt-in to provide after purchase experience data. Opting in requires the customer to indicate that he/she wants to take part in providing after purchase experience data to the after purchase experience program system. The customer may opt-in via the Internet, visiting a financial institution, text messaging, voice messaging, accessing an interface, a mobile application, or the like. In some embodiments, a customer may not need to opt-in to provide after purchase experience data. In this way, the system may allow the customer to passively input after purchase experience data. This passive input may be provided via online banking or mobile application to the customer.

A determination is made as to whether the customer may provide rich data regarding a product or merchant. Rich data includes data from a customer that actually communicated with a merchant, independent of if a purchase is made. In other words, the data is from a real customer actually purchasing a product or visiting a merchant, instead of an individual or merchant attempting to provide reviews or recommendations that are inaccurate. Providing reviews or recommendations that are inaccurate may be where the individual providing the review either did not purchase the product or use the product, but instead may have alternative reasons for providing a review of the product. For example, if an individual works for a competing product, the individual may provide in accurate reviews of the product so that more people who read the reviews may select the competing product based on the poor review.

The system may determine whether a customer may provide rich data in several ways, including but not limited to, the customer making a purchase using a payment means requiring financial institution authorization, using a coupon that is tracked by a financial institution, or geo-localization of the customer.

Once it is determined that a customer may be able to provide rich data for a product or merchant, the system may, in some embodiments, proactively send the customer mechanisms for providing after purchase experience data to the system. Sending mechanisms to provide after purchase experience data may include sending these mechanisms via email, text message, voice message, an interface, mobile applications, online, online banking, or the like. In other embodiments, the system may passively provide the customer with mechanisms for providing after purchase experience data to the system. In this way, the system does not inundate the customer with requests for after purchase experience data, but instead the system makes the mechanisms for providing after purchase experience data available to the customer. For example, the customer may log-in to his/her online banking where the system may provide the customer mechanisms for providing after purchase experience data for merchants which the customer may provide rich data. In this way, the customer may select to input after purchase experience data when it is convenient to him/her and not be inundated with reminders or notifications to provide after purchase experience data.

Mechanisms for providing after purchase experience data may be provided to the customer by several means, including, but not limited to email, text message, voice message, an interface, mobile applications, online, online banking, ATM machines, merchants, financial institution establishments, telephone communications, etc. Furthermore, mechanisms for providing after purchase experience data may include any mechanism that allows a customer to provide data indicating his/her experience with respect to a product, a merchant, or the customer's total purchase experience. These mechanisms may include, but are not limited to a survey, a rating (such as on a scale of 1 to 5), a written description, a voice message, a text message, or the like received from the customer regarding a product, a merchant, or the customer's total purchase experience.

Once the after purchase experience program system receives the rich data from the customer, the system may then compile the data into a directory. In some embodiments, the data may be compiled into directories for distribution to customers, merchants, or a data share platform. The data distributed may be in aggregate form, such that individual customer inputs are not recognized or by individual form, such that individual customer inputs may be recognized and associated with an alias ID of the customer. In this way, the recipient of after purchase experience data may be a customer, merchant, or the shared data platform. Each of these recipients may receive data in the form of aggregate or individualized data, such that the recipient may analyzed the data as necessary.

In some embodiments, the after purchase experience data may be distributed to a merchant. The merchant may be able to select aggregate or individual form data. For example, the after purchase experience data may be aggregated such that all data regarding a specific merchant is compiled. This data may be provided to the merchant, such that the merchant may receive feedback from actual customers regarding the merchant's products, services, or customer service. In some embodiments, if a merchant receives the after purchase experience data, the merchant may have to provide payment to whoever collected that data. In some embodiments, the merchant may be a commercial partner of the financial institution and be provided the after purchase experience data because of the commercial partnership without any fee associated with receiving the data. In other embodiments, merchants may be able to access the data freely. In this way, the aggregate after purchase experience data may be widely publicized or may be privately shared. However, individualized after purchase experience data may be protected, such that personal information may not be identifiable to the receiver of the data.

In some embodiments, the after purchase experience data may be distributed to customers. Customers may receive aggregate or individual after purchase experience data. For example, a customer may receive aggregate data indicating that several other customers have eaten at a particular restaurant and recommend it. In another example, the customer may receive individual data indicating that the customer has eaten at that restaurant before and provided negative feedback. Customers may be able to receive after purchase experience data before, while, or after the customer is communicating with a merchant. In this way, the customer may have access to all other after purchase experience data available at anytime during the communications with the merchant.

In some embodiments, the after purchase experience data may be distributed to a data share platform. The data provided to the data share platform may only be in the aggregate form, to ensure individual customer personal identification security. The data share platform may allow for data, not necessarily of the recommendation/review type, to be shared with other companies or other divisions of the financial institution. This data may be mined from the data provided from the after purchase experience data provided by customers. For example, in one specific geographical location, it may be determined that customers are generally purchasing diesel fuel and not gasoline. Many companies may find this information useful for marketing, targeting, promoting, etc. Thus, the financial institution may be able to provide this type of data, received as part of the collection of after purchase experience data, to companies to utilize.

In some embodiments, promotional offers may be provided to customers participating in the after purchase experience program. The customer receiving the promotional offer may either elect to retain the promotional offer, elect for friends of the customer to receive the promotional offers, or a combination thereof. In some embodiments, these offers may be from the financial institution in response to the customer taking the time to provide after purchase experience data. In some embodiments, these offers may be from the merchant in response to a customer's negative or positive response to the merchant. The merchant may provide the offer through the financial institution by identifying an alias ID of the customers the merchant may wish to provide offers to. In turn, the financial institution may determine personal information for the customer via the alias ID and provide the customer with the promotional offer. In some embodiments, the offers may be sent to the customer via a network, to the customer's customer system. In other embodiments, the offer may be sent to the customer via text massage, voice message, standard mail, a mobile application, to an email address, to a social network site of the customer, and/or the like. In some embodiments, the customer may pass the offers on to another individual through social networking, financial institution provided friends list, emailing, text messaging, mobile application, etc. such that the other individual may use the offer.

An offer that may be provided to the customer may be in the form of a discount, rebate, coupon, etc. that may expire within a predetermined amount of time or may be available to the customer at any time he/she wishes to make a transaction.

Embodiments of the invention relate to systems, methods, and computer program products for providing after purchase experience information, comprising determining that a customer communicated with a merchant, wherein the communication is an indication that the customer approached the merchant or approached a product of the merchant; providing, based at least in part on the customer communication with the merchant, a mechanism that allows the customer to provide input data regarding the customer's communication with the merchant; receiving the mechanism comprising customer input at a storage device; compiling customer input data retrieved from the mechanisms in one or more directories; receiving a request from a requestor to access the customer input data in the one or more directories; and providing customer input data from the one or more directories to the requestor based at least in part on the request for access the customer input data.

In some embodiments an anonymous identification is associated with the customer providing the customer input data. Providing customer data from the one or more directories to the requestor further comprises distributing customer data from one customer to the requestor with the anonymous identification of the customer.

In some embodiments, compiling customer input data retrieved from the mechanism in one or more directories further comprises compiling the anonymous identification of the customer with the customer data retrieved from the mechanism in the one or more directories.

In some embodiments, providing data from the one or more directories to the requestor further comprises distributing aggregated data, wherein the aggregated data comprises data from multiple mechanisms in aggregate. In some embodiments, the customer input data may be distributed from the one or more directories to a data share platform. The data share platform comprises the customer input data from the one or more directories and secondary data determined from the customer input data retrieved from the mechanism. Furthermore, the data share platform is accessible and searchable by a qualified entity.

In some embodiments, determining that the customer communicated with the merchant further comprises a customer transaction at the merchant, wherein the transaction is determined by an authentication of the transaction. Determining that the customer communicated with the merchant further comprises the customer visiting the merchant place of business.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating an after purchase experience program process, in accordance with one embodiment of the present invention;

FIG. 2 provides an after purchase experience program system environment, in accordance with one embodiment of the present invention;

FIG. 3 provides a process map illustrating a customer's decision process, in accordance with one embodiment of the present invention;

FIG. 4 provides a process map illustrating a customer request for after purchase experience data, in accordance with one embodiment of the present invention;

FIG. 5 provides a process map illustrating a merchant request for after purchase experience data, in accordance with one embodiment of the present invention;

FIG. 6 provides a process map illustrating after purchase experience data on the data share platform, in accordance with one embodiment of the present invention;

FIG. 7 provides an embodiment of a mechanism to provide after purchase experience data, in accordance with one embodiment of the present invention; and

FIG. 8 provides an embodiment of a merchant feedback interface, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Furthermore, as used herein, the term “product” shall mean any good, service, event, etc. that may be offered by a merchant. A “merchant” as used herein may refer to a manufacturer, retailer, service provider, event provider, warehouse, supplier, commercial partner of a financial institution, and/or the like. A “purchase” as used herein may refer to any transaction, lease, currency exchange, product exchange, negotiation for a product/good, barter, or the like between a customer and a third party. A purchase may include a transaction, but is not limited to person-to-merchant transactions, but instead may also include person-to-person, bill pay, etc. types of transactions. A purchase may be made for a product, good, service, etc. In addition, the term “offer” is used herein to denote any form of offer, promotion, rebate, coupon, incentive, and/or the like offered for the purchase, lease, and/or the like of a product.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

Throughout the disclosure specific customer action is described. Specific customer action may be customer requests, customer inputs such as on an interface, or other manually provided data the customer may provide to the data share platform. It is understood that the invention is meant to provide after purchase experience data to a system to distribute the data to customers, merchants, or data share platforms. In this way, the customer action described in further detail below may be automated.

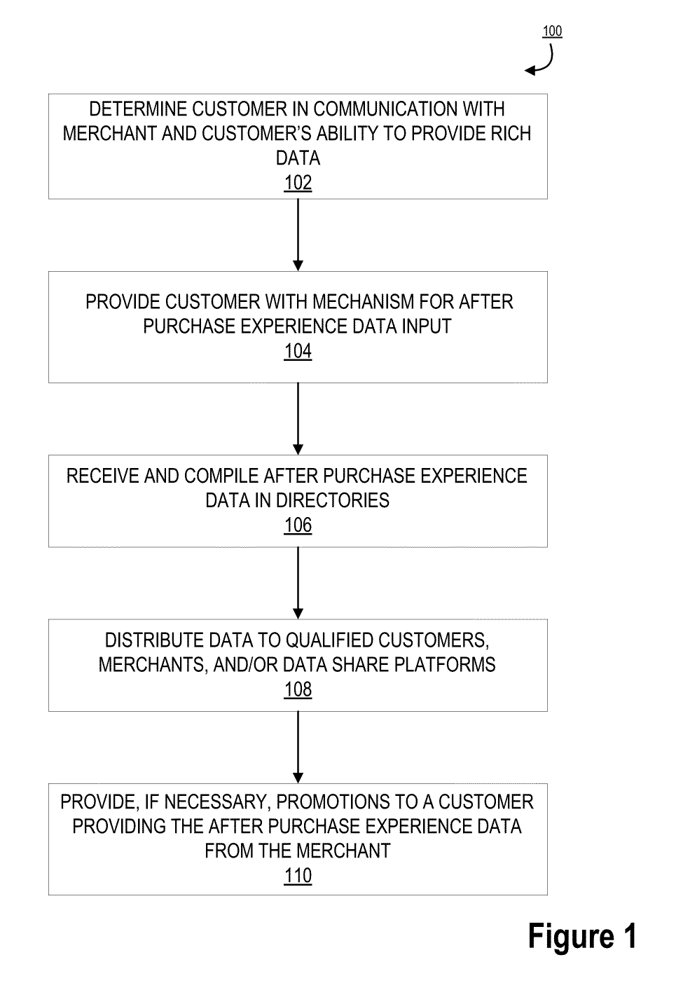

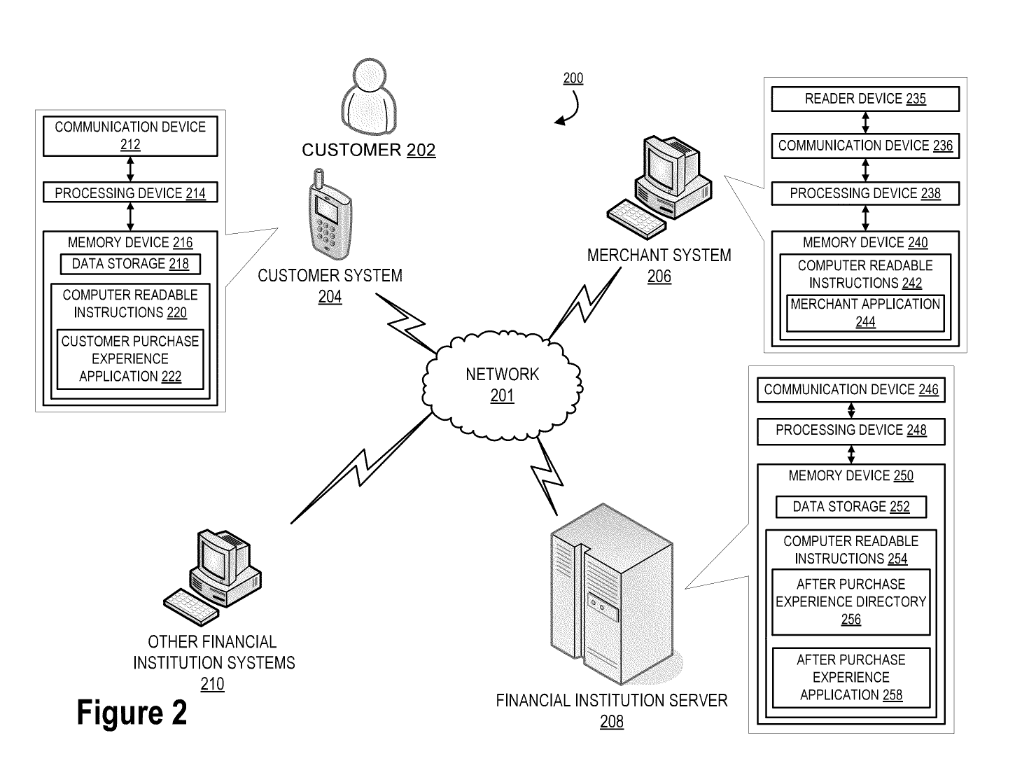

FIG. 1 illustrates a high level process flow for an after purchase experience program process 100, which will be discussed in further detail throughout this specification with respect to FIGS. 2 through 8. The first step in the process 100 is the determination if a customer is in communication with a merchant at block 102. The communication may be the customer making a purchase at the merchant with a payment means requiring financial institution authentication, using a coupon that may be tracked by a financial institution, or geo-localization of the customer. To that end, if the customer is in communication with the merchant a determination is made as to whether the customer may provide rich data as a result of the communication. Rich data includes data from a customer that actually communicated with a merchant. In other words, the data is from a real customer actually purchasing from or visiting a merchant. The next step in the process 100, at block 104 the customer is provided a mechanism to input after purchase experience data. Once the customer has inputted after purchase experience data, it is received and compiled in directories, as illustrated in block 106. Next, in block 108 the data is distributed to authorized customers, merchants, and/or data share platforms upon request. Finally, if necessary, in block 110 promotions are provided to the customer whom inputted after purchase experience data. In this way, the promotions may act as an incentive for the customer to participate and provide after purchase experience data to the system.

FIG. 2 illustrates an after purchase experience program system environment 200, in accordance with one embodiment of the present invention. As illustrated in FIG. 2, the financial institution server 208 is operatively coupled, via a network 201 to the customer system 204, to other financial institution systems 210, and to merchant system 206. In this way, the financial institution server 208 can send information to and receive information from the customer system 204, the other financial institution systems 210, and the merchant system 206, to send and receive information pertaining to the collection and distribution of after purchase experience data. FIG. 2 illustrates only one example of an embodiment of an after purchase experience program system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the customer 202 is an individual. The individual may be an account holder at the financial institution or not associated with the financial institution. The individual may wish to purchase products from a merchant, visit a merchant establishment, or otherwise communicate with a merchant. In some embodiments, the customer may be a user of the after purchase experience program. In some embodiments, the customer 202 may be a merchant or a person, employee, agent, independent contractor, etc. acting on behalf of the merchant to communicate with a second merchant.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the customer system 204, the merchant systems 206, and the other financial institution computer systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of an after purchase experience directory 256.

In another embodiment the computer-readable instructions 254 stored in the memory device 250 includes the computer-readable instructions 254 of an after purchase experience application 258. In some embodiments, the memory device 250 includes data storage 252 for storing data related to the financial institution including but not limited to data created and/or used by the after purchase experience directory 256 or the after purchase experience application 258.

In the embodiment illustrated in FIG. 2 and described throughout much of this specification, the after purchase experience directory 256 stores the received and requested after purchase experience data for the system. The after purchase experience directory 256 allows for storage of the mechanisms for providing after purchase experience data, storage of customer completed mechanisms for providing after purchase experience data, storage of requests for after purchase experience data, storage of alias ID information, storage of promotional offers, and storage of customer 202 friend lists. The after purchase experience directory 256 stores the after purchase experience data in directories based on the individual customer 202 providing the data, the merchant, the merchant classification (e.g., sporting goods, home improvement, grocery, etc.), geographic location, and the like. In this way, the data may be organized and easily accessible by the system upon request.

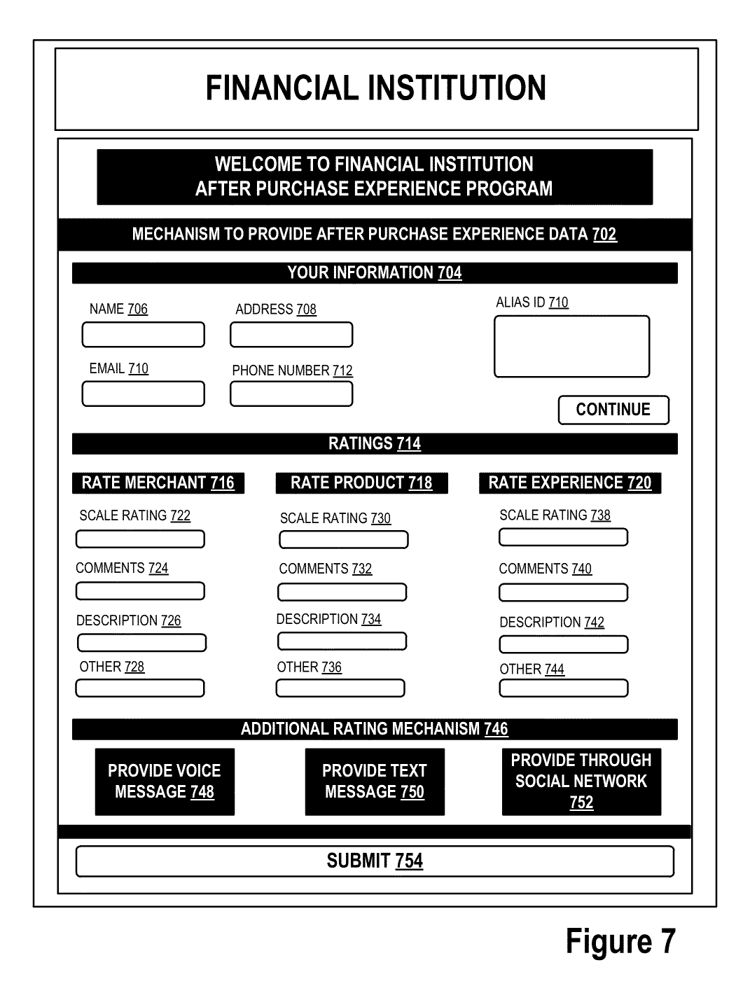

In some embodiments, the after purchase experience directory 256 stores the mechanisms customers 202 use to provide after purchase experience data. These mechanisms may include any mechanism that allows a customer 202 to provide data indicating his/her experience with respect to a product, a merchant, or the customer's total purchase experience. The mechanisms may include, but are not limited to a survey, a rating scale, a form for the customer 202 to provide written description, a voice message system, a text message system, or the like that the customer 202 may use to provide the system with data regarding a product, a merchant, or the customer's total purchase experience. An example of a mechanism that a customer 202 may use to provide after purchase experience data to the system is further illustrated by the interface depicted in FIG. 7. These mechanisms may be provided to the customer 202 either proactively or passively depending on the customer 202 in which the mechanism is directed. The mechanisms may be provided to the customer 202 by email, text message, voice message, an interface, mobile applications, online, online banking, or the like. For example, the customer 202 may log-in to his/her online banking where the customer 202 may be provided with mechanisms for the customer 202 to provide after purchase experience data for merchants the customer 202 has recently communicated with.

In some embodiments, the after purchase experience directory 256 stores customer 202 completed mechanisms for providing after purchase experience data. In this way, when a customer 202 inputs some information onto a mechanism, the after purchase experience directory 256 may store the input into a directory.

For example, in some embodiments, the mechanism that allows a customer 202 to provide data may comprise a survey. One of ordinary skill in the art will realize that although the following describes in detail a survey and survey response, many or all of the descriptions of the survey may be applied to the other mechanisms that allow a customer 202 to provide after purchase experience data. A survey response may include one or more answers to the one or more questions included in the survey that was provided to the customer 202. It will also be understood that the survey response may include and/or take any form, including one or more of the forms previously mentioned herein. For example, in some embodiments, the survey response takes the form of a customer 202—and/or system-created e-mail, document, voice mail, text message, instant message, and/or the like. In some embodiments, the form of the survey response is such that the system is configured to read and/or process some or all of the information provided in the survey response. However, in other embodiments, some or all of the information provided in the survey response must be manually entered and/or inputted into the system in order for the system to read and/or process the information.

In some embodiments, the survey response (and/or information associated with the survey response) is included in and/or associated with the survey. For example, in some embodiments, the survey includes instructions for the customer 202 to complete and communicate a survey response to the financial institution server 208. In some embodiments, the survey takes the form of an electronic document having one or more fillable fields, such that the customer 202 may respond to the survey and communicate the survey response to the financial institution server 208. In some embodiments, the survey is configured to be automatically transmit to the financial institution server 208 once the customer 202 completes the survey. In some embodiments, a survey response for one matter may serve as a survey response for one or more other matters.

Further, in some embodiments, the system is configured to use information from the survey response to compile and store data relating to after purchase experience in the after purchase experience directory 256. The data may be compiled by category such as, but not limited to by individually, by merchant, by geographic location, or the like.

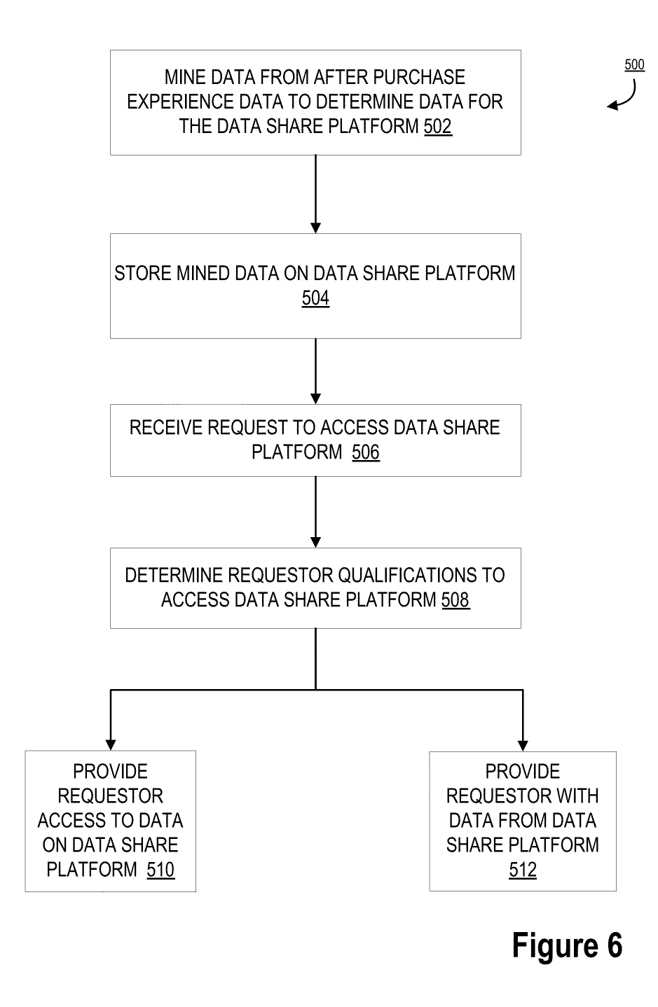

In some embodiments, the after purchase experience directory 256 stores the requests for after purchase experience data. In some embodiments, requests for after purchase experience data may be made from any entity wishing to receive after purchase experience data relating to a product or merchant. These entities may include customers, merchants, or data share platform requestors. The data share platform requestors may be any entity that wishes to receive and/or utilize the information that is on the data share platform, which will be discussed in more detail below with respect to FIG. 6. The data from on the after purchase experience directory 256 is stored based on product, customer, or merchant. The request, in some embodiments, may be made in the aggregate form or in the individual form. The aggregate form provided the requestor with aggregated data. For example, a manufacturer may request data related to a single product that the manufacturer produces. The manufacturer, if selecting the aggregate form, may receive compilation data from all customers 202 who provided after purchase experience data for that product. In yet other embodiments, requests for the after purchase experience data may be in individual form. The Individual form provides the requestor with individualized data. For example, if a customer 202 enters a merchant with which the customer 202 has had previous communications, the customer 202 may request and receive his/her prior after purchase experience data relating to the merchant. This may especially be useful to the customer 202 if it has been several years since the customer 202 communicated with the merchant. In another example, a merchant may be able request after purchase experience data in individual form, such that the merchant may view each individual customer's after purchase experience data. This data may be presented to the merchant using a customer alias ID, such that the customer's identification may not be disseminated to the merchant.

In some embodiments, the after purchase experience directory 256 stores alias ID information. If the after purchase experience data is distributed by individual form, the data is distributed with an alias ID associated with the data. In this way, the receiver of the data may not know any personal identifiable information about the customer providing the data. However, the financial institution may know the name, account numbers, etc. of the person associated with the alias ID.

The alias ID may be any unique identifier for a customer 202, not including any potentially sensitive personal information, such as the customer's social security number or account number. Typically, the alias ID is an identifier the customer 202, friends, and/or family may recognize as uniquely associate with the customer 202, similar to a screen name or the like. In this way, a merchant requesting after purchase experience data may not know the customer's identity. An alias ID may be, for example, a number, a portion of an email address, a social networking ID, and/or the like.

In some embodiments, the merchant may request to provide a customer 202 or a plurality of customers 202 with promotions based on the customer's or customers' after purchase experience data. The merchant may send a request to provide a customer 202 or customers 202 with a promotion to the financial institution server 208. For example, a merchant may wish to provide a discount to a customer 202, in the form of a coupon for 20% off the customer's next purchase. The merchant will provide that discount to the financial institution server 208 and will also provide the alias ID associated with the customer 202 in which the discount should be directed. The alias ID will be provided to the merchant based on the merchant's request to receive individual form or aggregate form after purchase experience data. The after purchase experience directory 256 may match the alias ID with a customer 202 and determine the customer's email address, phone number, street address, and/or the like. In this way, the financial institution server 208 may provide the customer 202 with the promotion that the merchant requested be provided to the customer 202.

In some embodiments, the after purchase experience directory 256 stores promotional offers that the merchants may provide to customers 202 of the after purchase experience program. A promotional offer that may be provided to the customer 202 may be in the form of a discount, rebate, coupon, etc. that may expire within a predetermined amount of time or may be available to the customer 202 at any time he/she wishes to make a transaction. The customer 202 receiving the promotional offer may either elect to retain the promotional offer, elect for friends/family of the customer 202 to receive the promotional offers, or a combination thereof. In some embodiments, these offers may be from the financial institution in response to the customer 202 taking the time to provide after purchase experience data. In some embodiments, these offers may be from the merchant in response to a customer's negative or positive response to the merchant. The directory within the after purchase experience directory 256 may provide computer readable instructions 254 to the processing device 248 for the distribution of promotional offers to a customer 202, irrespective of whether the financial institution or the merchant requested the offer to be distributed to the customer 202.

In some embodiments, merchants providing the offers may also be commercial partners of the financial institution offering the after purchase experience program. If this is the case, it is possible that the offers provided may be more beneficial to a customer 202 than other offers that may be provided by merchants. This is largely due to the unique position the financial institution is in with respect to the commercial partner. The commercial partner may have commercial banking needs such as mortgages, lines of credit, financial accounts, etc. that may be provided by the financial institution. In exchange for providing these financial services to the commercial partner the commercial partner may provide special offers to the financial institution. In this way, the commercial partner may receive financial services from the financial institution, while the financial institution may be able to receive discounted products from the commercial partner. In some embodiments, the commercial partner may not be associated with the financial institution, but instead, wish to provide offers to customers 202 through the after purchase experience program.

The merchant may provide the offer through the financial institution by identifying an alias ID of the customers 202 the merchant may wish to provide offers to. In turn, the financial institution may determine personal information for the customer via the alias ID and provide the customer 202 with the promotional offer. In some embodiments, the offers may be sent to the customer 202 via a network 201, to a customer system 204. In other embodiments, the offer may be sent to the customer 202 via text massage, voice message, standard mail, a mobile application, to an email address, to a social network site of the customer 202, and/or the like. In some embodiments, the customer 202 may pass the offers on to another individual through social networking, financial institution provided friends list, emailing, text messaging, mobile application, etc. such that the other individual may use the offer.

If the customer 202 requests the promotional offer be provided to another individual, the customer 202 may provide a friends list to the financial institution server. The friends list may be stored in the after purchase experience directory 256, such that when a promotional offer is being provided to a customer 202 the after purchase experience application 258 may recognize individuals on the customer's friend list, and direct the promotional offers to the individuals on the friend list.

In the embodiment illustrated in FIG. 2 and described throughout much of this specification, the after purchase experience application 258 allows for the distribution of mechanisms, the collection, compilation of data into directories, and distribution of requested data for the after purchase experience data program.

In some embodiments, the after purchase experience application 258 may receive an indication from a customer 202 that he/she would like to opt-in to provide after purchase experience data to the system. In this way, each time the customer 202 communicates with a merchant, the customer 202 may receive a mechanism for providing after purchase experience data to the system. In some embodiments, the customer 202 may be a customer of the financial institution providing the after purchase experience program. In other embodiments, the customer 202 may not be a customer of the financial institution providing the after purchase experience data program.

In some embodiments, a customer 202 may not be required to opt-in to the after purchase experience program. In this way, the after purchase experience application 258 may receive after purchase experience data from customers 202 that did not opt-in to the program. In some embodiments, the customer 202 may receive mechanisms for providing after purchase experience data proactively. In other embodiments, customer 202 may provide the after purchase experience application 258 with after purchase experience data passively.

In some embodiments, the after purchase experience application 258 may proactively provide the customer 202 with mechanisms for providing after purchase experience data. Proactively providing the customer 202 with mechanisms for providing after purchase experience data includes sending the mechanisms over a network 201 via email, text message, voice message, an interface, mobile applications, online, online banking, or the like. In some embodiments, in order for a customer 202 to receive proactive mechanisms in this way, the customer 202 may have previously opted-in to the program. However, in some embodiments the customer 202 may receive mechanisms for providing after purchase experience data even when he/she did not opt-in to the program. Proactively sent mechanisms for providing after purchase experience data may be stored in the after purchase experience directory 256. The after purchase experience application 258 may retrieve the stored mechanisms and provide them to the customer 202.

In some embodiments, the after purchase experience application 258 may passively provide the customer 202 with mechanisms for providing after purchase experience data. In this way, the after purchase experience application 258 does not inundate the customer 202 with requests for after purchase experience data, but instead the after purchase experience application 258 makes the mechanisms for providing after purchase experience data available to the customer 202, if the after purchase experience application 258 recognized that the customer 202 may be able to provide rich data for a merchant. For example, the customer 202 may log-in to his/her online banking where the after purchase experience application 258 may provide the customer 202 mechanisms for providing after purchase experience data for merchants for which the customer 202 will provide rich data. In this way, the customer 202 may select to input after purchase experience data when it is convenient to him/her and not be inundated with reminders or notifications to provide after purchase experience data.

Prior to the customer 202 receiving the mechanism, the after purchase experience application 258 may determine if a customer 202 may provide rich data regarding a product or merchant, and thus be a candidate to provide after purchase experience data to the after purchase experience application 258 either proactively or passively. Rich data includes data from a customer 202 that actually communicated with a merchant, independent of if a purchase is made. A communication with a merchant may include, but is not limited to, the customer 202 going to the merchant's place of business, the customer 202 browsing the merchant's website, the customer 202 browsing other electronic communications from a merchant, telephonic communications with a merchant, and/or the like.

The after purchase experience application 258 may determine if a communication between a customer 202 and a merchant has been made, such that the customer 202 may provide rich data. This determination may be made in several ways, including but not limited to, determining that the customer 202 made a purchase using a payment means requiring financial institution authorization, the customer 202 making a purchase using a coupon that is tracked by a financial institution, or using geo-localization of the customer 202 in comparison to the merchant.

A payment means requiring financial institution authorization may be tracked by the financial institution providing the authorization. Payment means requiring financial institution authorization may include, but are not limited to, credit cards, debit cards, e-wallet purchases, purchases using a line-of-credit, and/or the like. In this way, the financial institution may determine the merchant for which the customer 202 is communication and/or product that the customer 202 is purchasing. For example, if the customer 202 is purchasing a product from a merchant using a credit card associated with that financial institution, the financial institution may be able to determine the specific product the customer 202 is purchasing and the specific merchant from which the customer 202 is purchasing the product. This may be true for any communications with a merchant, either in the merchant's place of business, online, in the field, or the like.

A payment means using a coupon may be tracked by a financial institution. In this way, if a customer 202 does not use a payment means that requires a financial institution authorization, such as a purchase with cash, the after purchase experience application 258 may still recognize the customer 202 as being in communication with a merchant. For example, a coupon in the Sunday paper may be monitored by a financial institution, merchant, or the like to determine the use of the coupon. Therefore, if a customer 202 purchases a product using that particular coupon, the financial institution or the merchant may recognize the purchase, the product the customer 202 is purchasing, and the merchant from which the purchase was made. With this information, the financial institution may determine that the customer 202 may be able to provide rich data for the merchant, the product, or the total purchase experience.

Geo-localization of the customer 202 allows the after purchase experience application 258 to determine if a customer 202 is communicating with a merchant. Geo-localization uses means to determine the customer's location. The customer's location may be determined by location data. Location data may be established by a point-of-sale (POS) device, mobile device of the customer 202, customer system 204, global positioning systems (GPS) data, accelerometer data, address of the customer 202, shopping patterns of the customer 202, or social media. Location of the customer could also be determined based on output from accelerometers, gyroscopes, earth magnetic field sensors, air-pressure sensors (altitude), etc. For example, if a customer 202 uses an application on his/her mobile phone when entering a merchant, a determination of the customer's location may be made based on the location of the customer's mobile phone. The customer 202 may access the financial institution's mobile application when entering a merchant. In this way, the financial institution may recognize the location of the customer 202. The after purchase experience application 258 may then make a determination that the customer 202 may be able to provide rich data for the merchant co-localized with the customer 202. This is because the after purchase experience application 258 recognized that the customer 202 is located at a specific merchant's place of business, based on the geo-location of the customer 202.

Once the after purchase experience application 258 determines that the customer 202 may provide rich data for a product, merchant, or total purchase experience, the after purchase experience application 258 allows for distribution of mechanisms for customers 202 to provide after purchase experience data. These mechanisms may be sent to the customer 202 proactively or passively as described above. Mechanisms may be distributed from the after purchase experience application 258 to customers 202 by several means, including, but not limited to email, text message, voice message, an interface, mobile applications, online, online banking, ATM machines, merchants, financial institution establishments, telephone communications, etc.

The mechanisms for providing after purchase experience data may include any mechanism that allows a customer 202 to provide data indicating his/her experience with respect to a product, a merchant, or the customer's total purchase experience. These mechanisms may be provided to the customer 202 either proactively or passively depending on the customer 202 in which the mechanism is directed. These mechanisms may include, but are not limited to a survey, a rating (such as a scale of 1 to 5), a written description, a voice message, a text message, or the like received from the customer 202 regarding a product, a merchant, or the customer's total purchase experience. An embodiment of a mechanism for providing after purchase experience data is described in more detail with respect to FIG. 7 below.

Once the after purchase experience application 258 receives a mechanism from a customer 202, in the form of a response, the after purchase experience application 258 may then compile the data into a directory within the after purchase experience directory 256. A response may include one or more answers to the one or more questions included in the mechanism that was provided to the customer 202. For example, in some embodiments, the customer 202 response takes the form of a customer 202 and/or system created e-mail, document, voice mail, text message, instant message, and/or the like. In some embodiments, the form of the response is such that the after purchase experience application 258 is configured to read and/or process some or all of the information provided in the response.

Further, in some embodiments, the system is configured to use information from the survey response to compile and store data relating to after purchase experience in the after purchase experience directory 256. The data may be compiled by category such as, but not limited to by individually, by merchant, by geographic location, or the like.

In some embodiments, the data may be compiled into directories within the after purchase experience directory 256 for distribution to customers 202, merchants, or a data share platform. The data distributed is performed by the after purchase experience application 258. The data that is distributed may be in an aggregate form or in an individual form. If the data is distributed in the aggregate form from the after purchase experience application 258, the data does not identify individual customers 202. If the data is distributed in individual form, the merchant, customer 202, or data share platform may receive after purchase experience data from individual customers 202. In order to protect the identity of the customer 202 providing individual form data, the data does not include the customer's name or any other personally identifiable information regarding the customer 202. However, the individual form data is sent from the after purchase experience application 258 to the requestor of the data with a customer 202 alias ID. In this way, the after purchase experience application 258 may know the identity of the customer 202 providing the after purchase experience data, but the requestor of the data may not.

In some embodiments, the after purchase experience application 258 may provide after purchase experience data to a customer 202 requestor. In some embodiments, a customer 202 requestor may be the customer 202 providing the after purchase experience data. In other embodiments, a customer 202 requestor may not be the customer 202 providing the after purchase experience data. In this way, a customer 202, typically through the use of a customer system 204 may request after purchase experience data from the after purchase experience application 258 through the use of a network 201. In some embodiments, the customer 202 may request the after purchase experience data. In other embodiments, the customer 202 may receive after purchase experience data without requesting the data. Based on the request from the customer 202, the after purchase experience application 258 may provide the customer 202 with after purchase experience data. The data may be distributed to the customer 202 in either an aggregate or individual form.

If the after purchase experience data is distributed in the aggregate form from the after purchase experience application 258 to a customer 202, the customer 202 may receive all compiled data relating to a merchant, a product, or a total customer experience at a merchant's place of business. The data received by the customer 202 may be in the form of graphs, charts, ratings, comments, overall performances, merchant product ratings, etc. that provides the customer 202 an indication as to other customers' reaction towards a merchant, the products a merchant sells, or the total purchase experience, such that the customer 202 may determine whether he/she would like to communicate with that merchant based on other customers after purchase experience data. In this way, the customer 202 may be able to review rich data from other customers who have communicated with the merchant recently, thus giving the customer 202 an indication as to other customers' satisfaction with the merchant, prior to the customer 202 communicating with the merchant.

If the data is distributed in individual form the customer 202 may receive his/her own prior after purchase experience data from the after purchase experience application 258. In this way, the after purchase experience application 258 may provide the customer 202 with his/her own prior after purchase experience data, such that the customer 202 may recollect his/her prior experiences at a merchant or with a product. For example, the customer 202 may enter into a merchant and recognize the merchant's place of business. However, the customer 202 may not have visited the merchant for several years and may have forgotten about his/her prior experience with the merchant. Therefore, the customer 202, through the customer system 204 may be able to retrieve his/her prior after purchase experience data from the after purchase experience application 258, such that he/she may recollect his/her prior experiences with the merchant. In some embodiments, the customer 202 may request individual form after purchase experience data. In other embodiments, the after purchase experience application 258 may provide the customer 202 with the individual form after purchase experience data independent of a request for the data.

In some embodiments, the after purchase experience application 258 may provide after purchase experience data to a merchant requestor. In this way, a merchant, typically through a merchant system 206 may request after purchase experience data from the after purchase experience application 258 through the use of a network 201. In some embodiments, the merchant may request the after purchase experience data. In other embodiments, the after purchase experience system may seek out merchants to distribute, without merchant request, the after purchase experience data. In some embodiments, the financial institution providing the after purchase experience program may request payment from the merchant in order to distribute the after purchase experience data to that merchant. Based on the request from the merchant, the after purchase experience application 258 may provide the merchant with after purchase experience data. The data may be distributed to the merchant in either an aggregate or individual form.

If the after purchase experience data is distributed in the aggregate form from the after purchase experience application 258 to a merchant, the merchant may receive all compiled data relating to the merchant, the products sold by the merchant, or the total customer experience at the merchant's place of business. The data received by the merchant may be in the form of graphs, charts, ratings, comments, overall performances, merchant product ratings, etc. that provides the merchant an indication as to customers reaction towards the merchant, the products the merchant sells, or the total purchase experience, such that the merchant may receive feedback from actual customers regarding the merchant's performance and the merchant's place of business. In this way, the merchant may be able to review rich data from customers 202 whom have communicated with the merchant recently. This data may provide the merchant with an indication as to its performance, the satisfaction of its customers, product reviews, and possible areas of improvement to provide a better experience for a customer 202.

If the data is distributed in individual form, the merchant may receive after purchase experience data from the after purchase experience application 258 in the form of individual customer 202 responses. In other words, the merchant may receive the same data that the customer 202 provided in the mechanism for providing after purchase experience data. In order to protect the identity of the customer 202 providing individual form data, the data does not include the customer's name or any other personally identifiable information regarding the customer 202. However, the individual form data is sent from the after purchase experience application 258 to the merchant requestor of the data with a customer 202 alias ID. In this way, the after purchase experience application 258 may know the identity of the customer 202 providing the after purchase experience data, but the merchant requesting the data may not. The merchant may receive the alias ID of the customer 202 as well as any ratings, comments, remarks, conclusions, or the like that the customer 202 may have provided via an after purchase experience mechanism. In this way, the merchant may be able to review, at an individual customer 202 level, rich data from customers 202 who have communicated with the merchant recently and determine how individual customer's rate the merchant's place of business, products, or total experience. This data may provide the merchant with an indication as to its performance, the satisfaction of its customers, product reviews, and possible areas of improvement to provide a better experience for a customer 202.

In some embodiments, the after purchase experience data may be distributed to a data share platform from the after purchase experience application 258. The data provided to the data share platform may only be in the aggregate form, to ensure individual customer 202 personal identification security. The data share platform may allow for data, not necessarily only data associated with the recommendation/review of merchants or products, to be shared with other companies or other divisions of the financial institution. This data may be mined from the data provided by a customer 202 within the mechanism for after purchase experience data that the customer 202 completed. Again, this data may not be directly related to the merchant, product, or total purchase experience, but it may be determined from the after purchase experience data received by the after purchase experience application 258. For example, in one specific geographical location, it may be determined that most of the responses to mechanisms to provide after purchase experience data from customers 202 for fuel provider merchants may indicate that customers 202 are generally purchasing diesel fuel and not unleaded gasoline. Many companies may find this information useful for marketing, targeting, promoting, etc. Thus, the financial institution may be able to provide this type of data, received as part of the collection of after purchase experience data, to companies to utilize. In another example, other divisions of the financial institution may utilize the after purchase experience data in a similar way. Other divisions of the financial institution may recognize that the majority of purchases at a retail merchant throughout the country are made using other financial institution payment means. The customers 202 may provide payment for a transaction using the other financial institution's payment instrument, such as a credit card, yet still provide after purchase experience data to the after purchase experience application 258 because of a communication between the other financial institution systems 210 and the after purchase experience application 258 through a network 201. The use of other financial institution payment means may indicate to the other divisions of the financial institution that a new credit card or other payment means may need to be implemented to compete with the other financial institution, as a payment instrument for retail stores.

The after purchase experience application 258 may also provide customers 202 or friends of customers with promotional offers. The promotional offers may be provided to the customers 202 based on a customer's 202 participation in the after purchase experience program, completion of a mechanism for providing after purchase experience data, or upon merchant review of the customer's after purchase experience data. The customer 202 receiving the promotional offer may either elect to retain the promotional offer, elect for friends of the customer to receive the promotional offers, or a combination thereof. In some embodiments, these offers may be from the financial institution in response to the customer 202 opting in to the after purchase experience program. In some embodiments, these offers may be from the financial institution in response to the customer 202 taking the time to provide after purchase experience data to the after purchase experience application 258. In some embodiments, these offers may be from the merchant in response to a customer's negative or positive response to the merchant or merchant's products. The merchant may provide the offer through the after purchase experience application 258 by identifying an alias ID of the customers 202 the merchant may wish to provide offers to. In turn, the after purchase experience application 258 may determine personal information for the customer 202 via the alias ID and provide the customer 202 with the promotional offer. In some embodiments, the offers may be sent to the customers 202 via a network, to the customer's customer system 204. In other embodiments, the offer may be sent to the customer 202 via text massage, voice message, standard mail, a mobile application, to an email address, to a social network site of the customer 202, and/or the like. In some embodiments, the customer 202 may pass the offers on to another individual through social networking, financial institution provided friends list, emailing, text messaging, mobile application, etc. such that the other individual may use the offer. In some embodiments, the customer 202 may elect to provide other individuals with the offers directly from the after purchase experience application 258. In this way, promotional offers that the customer 202 receives may be directed to other individuals selected by the customer 202, such that the customer 202 may not see the promotional offer, but instead it is directly sent to the other individual. A promotional offer that may be provided to the customer 202 may be in the form of a discount, rebate, coupon, etc. that may expire within a predetermined amount of time or may be available to the customer 202 at any time he/she wishes to make a transaction.

FIG. 2 also illustrates a customer system 204. The customer system 204 generally comprises a communication device 212, a processing device 214, and a memory device 216. The processing device 214 is operatively coupled to the communication device 212 and the memory device 216. The processing device 214 uses the communication device 212 to communicate with the network 201 and other devices on the network 201, such as, but not limited to the financial institution server 208, the merchant systems 206, and the other financial institution computer systems 210. As such, the communication device 212 generally comprises a modem, server, or other device for communicating with other devices on the network 201.

As further illustrated in FIG. 2, the customer system 204 comprises computer-readable instructions 220 stored in the memory device 216, which in one embodiment includes the computer-readable instructions 220 of a customer purchase experience application 222. In this way, in some embodiments, a customer 202 may be able to opt-in to the after purchase experience program, receive mechanisms to provide after purchase experience data, provide responses to mechanisms for providing after purchase experience data, receive after purchase experience data, and provide friends list for promotional offer delivery, and/or the like using the customer purchase experience application 222. In some embodiments, the memory device 216 includes data storage 218 for storing data related to the customer system including but not limited to data created and/or used by the customer purchase experience application 222. A “customer system” 204 may be any mobile communication device, such as a cellular telecommunications device (e.g., a cell phone or mobile phone), personal digital assistant (PDA), a mobile Internet accessing device, or other customer system including, but not limited to PDAs, pagers, mobile televisions, gaming devices, laptop computers, desktop computers, cameras, video recorders, audio/video player, radio, GPS devices, any combination of the aforementioned, or the like. Although only a single customer system 204 is depicted in FIG. 2, the after purchase experience system environment 200 may contain numerous customer systems 204.

The merchant system 206 generally comprises a reader device 235, a communication device 236, a processing device 238, and a memory device 240. The processing device 214 is operatively coupled to the communication device 236 and the memory device 216. The processing device 238 uses the communication device 236 to communicate with the network 201 and other devices on the network 201, such as, but not limited to the financial institution server 208, the customer system 204, and the other financial institution computer systems 210. As such, the communication device 236 generally comprises a modem, server, or other device for communicating with other devices on the network 201. Furthermore, the reader device 235 allows a merchant system 206 to determine if a customer 202 is in communication with the merchant. In some embodiments, the reader device 235 may be a point-of-transaction device, a point-of-sale device, or a like device able to receive and/or process the purchase of a product at the merchant. A reader device 235 may also comprise a type of location device, such that a merchant may be able to detect a customer 202 within the merchant's place of business.

As further illustrated in FIG. 2, the merchant system 206 comprises computer-readable instructions 242 stored in the memory device 240, which in one embodiment includes the computer-readable instructions 242 of a merchant application 244. In this way, in some embodiments, a merchant may be able to request and receive after purchase experience data using the merchant application 244. In some embodiments, the memory device 240 includes data storage for storing data related to the merchant system 206 including but not limited to data created and/or used by the merchant application 244.

Furthermore, the merchant application 244 allows the merchant to provide the after purchase experience application 258 promotional offers to provide to customers 202 based on the customers' 202 after purchase experience data. The merchant systems 206, in some embodiments, may provide the after purchase experience application 258 data with respect to the offers available from the merchant for customers 202. This data may include all offers that merchants may wish to provide to customers 202 of the after purchase experience program, offers for specific customers 202 of the after purchase experience program, and/or the like. The data may include the offer, limitations on the offer, the product the offer is directed, and the like. The limitations on the offer may be a percentage discount not to exceed, a location limitation, a number of offers provided limitation, a number of products purchased using the offer limitation, an amount off limitation, etc.

In some embodiments, the merchant systems 206 may receive requests from the after purchase experience application 258 to provide customers 202 who have either opted into the after purchase experience program or has provided after purchase experience data to the system. The requests may be made from the after purchase experience application 258 through the network 201 to the merchant systems 206 for the merchant to review and consider providing an offer for a product to a customer 202 of the after purchase experience program.

FIG. 2 depicts only one merchant system 206 within the after purchase experience system 200, however, one of ordinary skill in the art will appreciate that a plurality of merchant systems may be communicably linked with the financial institution server 208 and the other devices on the network 201, such that each merchant who may request and/or receive after purchase experience data is communicably linked to the devices on the after purchase experience system 200 in the same or a similar way as the merchant system 206 is as illustrated.

The other financial institution systems 210 are operatively coupled to the financial institution server 208, the customer system 204, and/or the merchant systems 206 through the network 201. The other financial institution systems 210 have systems with devices the same or similar to the devices described for the financial institution server 208 and/or the customer system 204 (e.g., communication device, processing device, and memory device). Therefore, the other financial institution systems 210 communicate with the financial institution server 208, the merchant systems 206, and/or the customer system 204 in the same or similar way as previously described with respect to each system. The other financial institution systems 210, in some embodiments, are comprised of systems and devices that allow the financial institution server 208 to access information at the other financial institution to determine if a customer 202 may be able to provide rich data with respect to a merchant or product. In other embodiments, the other financial institution systems 210 may provide the financial institution server 208 with information indicating the ability for the customer 202 to provide rich data with respect to a merchant or product.

It is understood that the servers, systems, and devices described herein illustrate one embodiment of the invention. It is further understood that one or more of the servers, systems, and devices can be combined in other embodiments and still function in the same or similar way as the embodiments described herein.

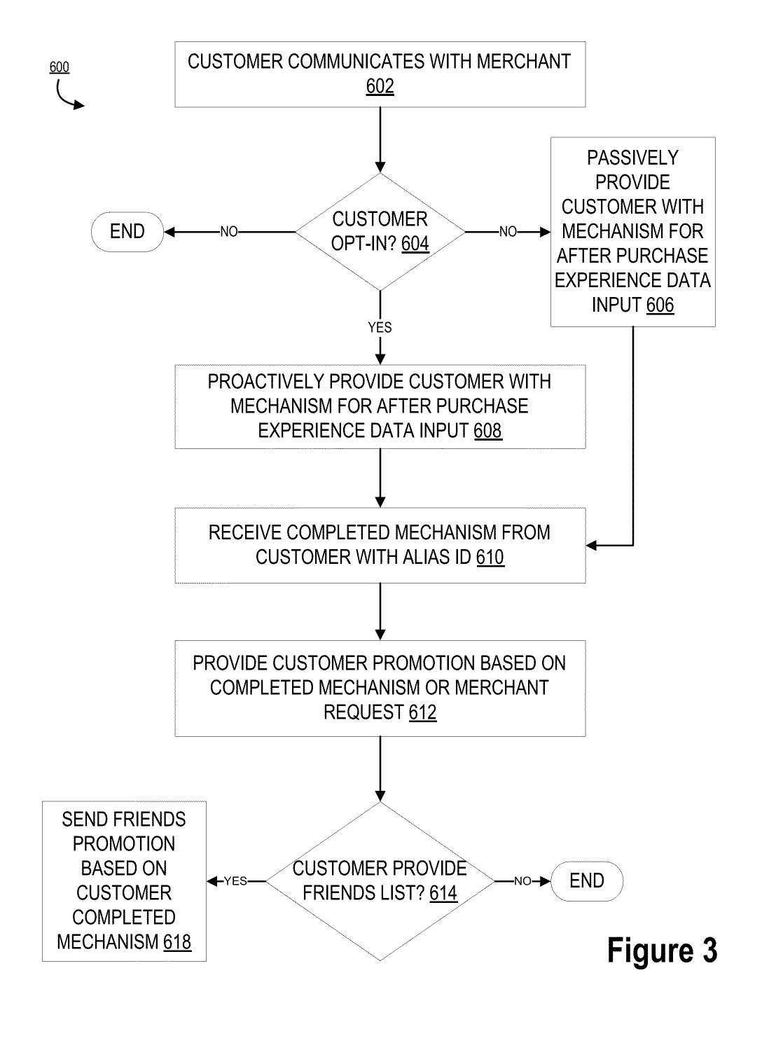

FIG. 3 illustrates a process map of a customer's decision process 600, in accordance with one embodiment of the present invention. As illustrated in block 602, a customer 202 may communicate with a merchant. Customer 202 communication with a merchant may include, but is not limited to, the customer 202 going to the merchant's place of business, the customer 202 browsing the merchant's website, the customer 202 browsing other electronic communications from a merchant, telephonic communications with a merchant, and/or the like where a customer 202 has contact with a merchant on the customer/merchant level of interaction. If it is determined that a customer 202 communicated with a merchant, the system may indicate that the customer 202 may be able to provide rich data for the merchant or products sold by the merchant.

As illustrated in block 604, a customer 202 may opt-in to the after purchase experience program using his/her customer system 204. Opting in requires a customer 202 to indicate that he/she wants to receive mechanisms to provide after purchase experience data to the system when he/she has communicated with a merchant. The customer 202 may opt-in via the Internet, visiting a financial institution, text messaging, voice messaging, accessing an interface, a mobile application, or the like. Once the customer 202 has opted in to the after purchase experience program the system may proactively provide the customer 202 mechanisms for the customer 202 to input after purchase experience data to the system, as illustrated in block 608. Returning to decision block 604, if the customer 202 does not opt-in to the after purchase experience program, the system may determine not to provide the customer 202 with mechanisms to provide after purchase experience data, as illustrated in the termination block. However, in some embodiments, even if the customer 202 does not opt-in to the after purchase experience program the system may determine to provide the customer 202 with mechanisms to provide after purchase experience data passively, as illustrated in block 606. In some embodiments, the customer 202 who opts-in to the program may receive mechanisms proactively. In some embodiments, the customer 202 who opts-in to the program may receive mechanisms passively. In some embodiments, the customer 202 who does not opt-in to the program may receive mechanism proactively. In yet other embodiments, the customer 202 who does not opt-in to the program may receive mechanisms passively.

The distribution of mechanisms to customers 202 may be achieved via email, text message, voice message, an interface, mobile applications, online, online banking, or the like. Proactively providing customers 202 with mechanisms, as illustrated in block 608, may be done prior to any indication from the customer 202 that he/she communicated with a merchant. The system may recognize a possible communication between the customer 202 and a merchant and thus proactively provide the customer 202 with a mechanism to the customer 202. For example, a customer 202 may enter a grocery store to purchase food. If the system, through for example geo-localization of the customer 202, recognizes that the customer 202 may be able to provide rich data for that specific grocery store, the system may provide the customer 202 with a mechanism prior to the customer purchasing any products within the merchant.

In some embodiments, as illustrated in block 606 the system may passively provide the customer 202 with mechanisms for after purchase experience data input. In this way, the customer 202 may find mechanisms and provide those mechanisms to the system, without the system proactively contacting the customer 202 to do so. For example, a customer 202 may have recently communicated with a merchant. The customer 202 may go on to his/her mobile banking application or online banking application and select a mechanism within the mobile or online banking platform, that the customer 202 may be able to input onto and provide to the system. In this way, the system may receive mechanisms from customers 202 without proactively sending the customer 202 a mechanism. But instead, provide mechanisms in locations that are convenient of the customer 202 to utilize to provide feedback. These passive mechanisms may be, but are not limited to, being located at an ATM, a mobile application, online banking, financial institution branch, a merchant itself, and/or the like.

Mechanisms for after purchase experience input may include any mechanism that allows a customer 202 to provide data indicating his/her experience with respect to a product, a merchant, or the customer's total purchase experience. These mechanisms may include, but are not limited to a survey, a rating (such as a rate of 1 to 5), a written description, a voice message, a text message, or the like received from the customer regarding a product, a merchant, or the customer's total purchase experience.

For example, FIG. 7a illustrates a mechanism for providing after purchase experience data input 702. In the embodiment illustrated in FIG. 7a survey is depicted as a mechanism for after purchase experience input. However, one of ordinary skill in the art will appreciate that a survey is not the only mechanism available for after purchase experience input. Other mechanisms may include, but are not limited to a survey, a rating (such as a scale of 1 to 5), a written description, a voice message, a text message, or the like received from the customer 202 regarding a product, a merchant, or the customer's total purchase experience.

At section 704 of the mechanism to provide after purchase experience data 702 the customer 202 is provided a section to input his/her information. The information the customer 202 may input includes his/her name 706, address 708, email 710, and phone number 712. Generally this personal information will not be provided to requestors of the after purchase experience data provided by the mechanism 702. However, the information allows the after purchase experience system to provide the customer 202 with promotional offers, etc. at the customer's address 708 or email 710. In section 710 of the information section 704, the customer 202 may provide an alias ID. An alias ID is any unique identifier for a customer 202, not including any potentially sensitive personal information, such as the customer's address. In this way, a requestor of after purchase experience data may not know the customer's identity. The customer 202 may input any alias ID he/she desires. The system may then determine if the alias ID has already been used by another customer 202. If the alias ID has not been used by another customer 202, the customer 202 is granted the alias ID upon selecting the continue button. If the selected alias ID is already in use by another customer 202, the customer 202 is prompted to provide an alternative alias ID.

Upon completion of the your information section 704, the customer 202 may then provide ratings for his/her experience in section 714. The customer 202 may rate a merchant 716, a product 718, and/or the customer's experience 720. At section 716, the customer 202 may rate a merchant. The rating may include the customer 202 completing one or more of the following sections. The customer 202 may provide scale rating 722, comments 724, descriptions 726, and/or other information 728. The scale rating section 722 allows a customer 202 to provide a rating of the merchant. This may be done in many ways, including but not limited to a 1-5 numerical scale, thumbs up/thumbs down, a star rating, like/dislike, etc. In this way, the customer 202 may be able to simply provide a number or selection instead of inputting a comment, to provide after purchase experience data to the system. The comments section 724 allows the customer 202 to input any comments relating to the merchant. The description section 726 allows the customer 202 to input a description of the merchant's place of business. The other section 728, allows a customer 202 to provide any other comments, remarks, or the like regarding the merchant.

At section 718, the customer 202 may rate a product purchased from a merchant. The rating may include the customer 202 completing one or more of the following sections. The customer 202 may provide scale rating 730, comments 732, descriptions 734, and/or other information 738. The scale rating section 730 allows a customer 202 to provide a rating of the product purchased from a merchant. This may be done in many ways, including but not limited to a 1-5 numerical scale, thumbs up/thumbs down, a star rating, like/dislike, scale, etc. In this way, the customer 202 may be able to simply provide a number or selection instead of inputting a comment, to provide after purchase experience data to the system. The comments section 732 allows the customer 202 to input any comments relating to the product. For example, the customer 202 may indicate that a product does more than advertised and is a wonderful item. The description section 734 allows the customer 202 to input a description of the product. For example, the customer 202 may have purchased the product online and only selected it by looking at pictures of the product. The customer 202 may provide a description that the product is actually much smaller than it appears in advertisements. The other section 736, allows a customer 202 to provide any other comments, remarks, or the like regarding the product.

At section 720, the customer 202 may rate the total purchase experience. The customer's total purchase experience may include the merchant, the merchant's layout and ambiance, the products available to the customer 202, customer service, etc. The rating may include the customer 202 completing one or more of the following sections. The customer 202 may provide scale rating 738, comments 740, descriptions 742, and/or other information 744. The scale rating section 738 allows a customer 202 to provide a rating of the customer's total purchase experience. Providing a rating of the customer's total purchase experience via a scale rating 738 may be done in many ways, including but not limited to a 1-5 numerical scale, thumbs up/thumbs down, a star rating, like/dislike, etc. In this way, the customer 202 may be able to simply provide a number or selection instead of inputting a comment, to provide after purchase experience data to the system. The comments section 740 allows the customer 202 to input any comments relating to the customer's total purchase experience. The description section 742 allows the customer 202 to input a description of the total purchase experience. The other section 744, allows a customer 202 to provide any other comments, remarks, or the like regarding the experience.

Next, the customer 202 may provide additional after purchase experience data using the additional rating mechanism section 746. The additional rating mechanism include, but are not limited to providing a voice message 748, providing a text message 750, or providing additional data via social networking 752. If the customer 202 selects to provide additional after purchase experience data using a voice message, the customer 202 may select the provide voice message section 748 and the customer 202 may then leave a voice message. The voice message may be recorded and subsequently sent to financial institution server 208 through a network 201. If the customer 202 selects to provide additional after purchase experience data use a text message, the customer 202 may select the provide text message section 750. In some embodiments, a text message will then be sent to the customer 202, so that the customer 202 may respond to the text message with his/her after purchase experience data. In other embodiments, the customer 202, upon selecting the provide text message section 750 will automatically be directed to the text messaging application of his/her customer device 204. If the customer 202 selects to provide data using his/her social network, the customer 202 may select the provide through social network section 752. In this way, the customer 202 may post via his/her social networking page, after purchase experience data for the system. Upon completion of the mechanism to provided after purchase experience data 702 the customer 202 may select the submit button 754 and submit the mechanism to the system.

Returning to FIG. 3, as illustrated in block 610, the system receives the completed mechanism from the customer 202. In some embodiments, the completed mechanism comprises the customer's alias ID. In other embodiments, the system provides an alias ID to the completed mechanism, such that when a merchant requests individual form after purchase experience data, the mechanism may be identified by the customer's alias ID and not any personal identifiable information of the customer 202. The customer 202 may submit the mechanism in several ways, depending on the mechanism and the way the customer 202 received the mechanism. The ways the customer 202 may submit the mechanism includes, but is not limited to, submitting the mechanism via a network 201, Internet, voice communications, text messaging, other text communications, mail, etc.

An alias ID is any unique identifier for a customer 202, not including any potentially sensitive personal information, such as the customer's social security number or account number. Typically, the alias ID is an identifier the customer 202, friends, and/or family may recognize as uniquely associate with the customer 202, similar to a screen name or the like. In this way, a merchant requesting after purchase experience data may not know the customer's identity. An alias ID may be, for example, a number, a portion of an email address, a social networking ID, and/or the like.

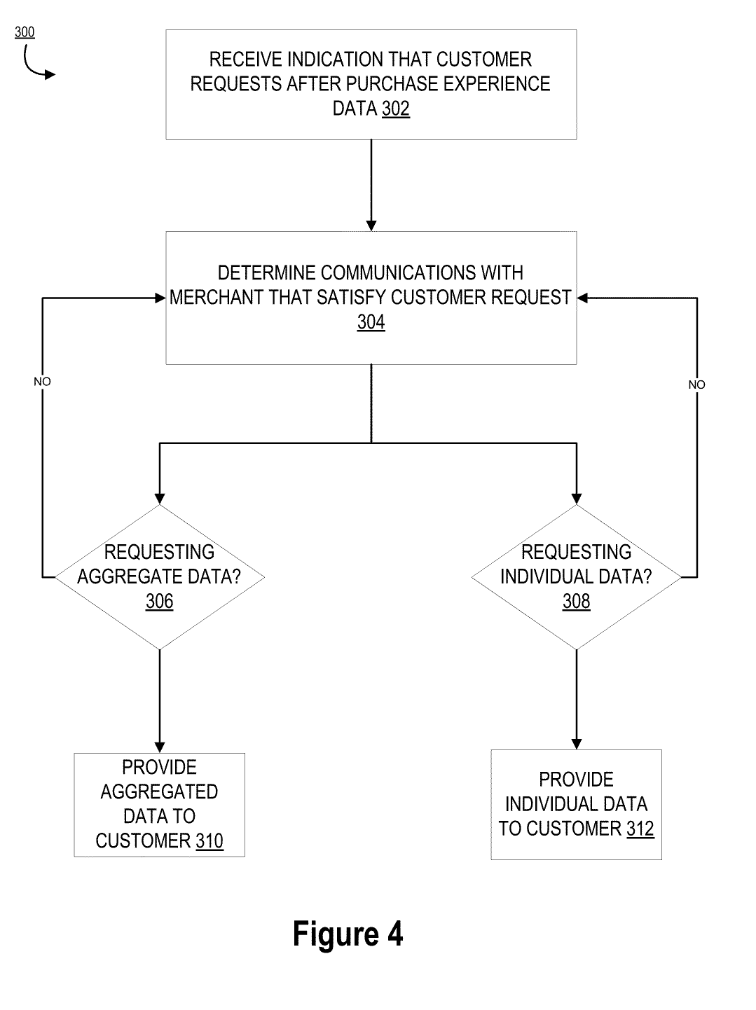

Once the system has received the completed mechanisms from customers 202 the system may compile them into directories and distribute them to customers 202, merchants, or a data share platform. These various distribution paths are discussed in further detail below with respect to FIGS. 4-6.

The customer 202 may then receive promotions based on the completed mechanism, as illustrated in block 612. In some embodiments, the customer 202 may receive promotional offers based on completing and returning the completed mechanisms to the system. In other embodiments, the customer 202 may receive promotional offers based on the customer's input on the mechanism. The promotional offers may be from the financial institution or a merchant. For example, a financial institution may provide an improved interest rate for individuals that complete a specified number of mechanisms a year. A promotional offer that may be provided to the customer 202 may be in the form of a discount, rebate, coupon, etc. that may expire within a predetermined amount of time or may be available to the customer 202 at any time he/she wishes to make a transaction. In some embodiments, the customer 202 may retain the promotional offer, as illustrated in block 612. In other embodiments, the customer 202 may provide a friends list in decision block 614. If the customer 202 has provided a friends list, the system may send the customer's friends promotional offers directly, based on the customer's response to mechanisms, as illustrated in block 618. If the customer 202 does not provide a friends list, the customer 202 may directly receive the promotional offers. Therefore, the customer 202 receiving the promotional offer may either elect to retain the promotional offer, elect for friends/family of the customer 202 to receive the promotional offers, or a combination thereof.

In some embodiments, the promotional offers may be sent to the customer 202 via a network 201, to a customer system 204. In other embodiments, the offer may be sent to the customer 202 via text massage, voice message, standard mail, a mobile application, to an email address, to a social network site of the customer 202, and/or the like. In some embodiments, the customer 202 may pass the offers on to another individual through social networking, financial institution provided friends list, emailing, text messaging, mobile application, etc. such that the other individual may use the offer.

FIG. 4 illustrates a process map for a customer 202 request for after purchase experience data 300, in accordance with one embodiment of the present invention. In block 302 the system receives an indication from a customer 202 that he/she requests after purchase experience data. In some embodiments, a customer 202 requestor may be the customer 202 providing the after purchase experience data. In other embodiments, a customer 202 requestor may not be the customer 202 providing the after purchase experience data. The indication the system may receive from the customer 202 requesting the after purchase experience data may, in some embodiments, be sent from a customer 202 via email, text message, online banking, mobile applications, interfaces, voice messaging, mail, or the like to the system. In other embodiments, the customer 202 may not provide a request for after purchase experience data in order to receive the data, but instead the system may provide the data to the customer 202 without a request from the customer 202.

Once the system receives a request from the customer 202 or the system determines to send after purchase experience data to the customer 202, the system may determine customer filters, which provide an indication as to which merchant or product the customer 202 wishes to receive after purchase experience for. In some embodiments, the customer 202 may indicate to the system which products and/or merchants for which the customer 202 wishes to receive after purchase experience data, such as specific brands, product types, product classifications, merchant types, merchant geographic location, and/or the like. For example, in the request for after purchase experience data, the customer 202 may indicate that he/she is wishing to purchase a television set, and therefore, requests after purchase experience data for several different brands of televisions. In yet another example, the customer 202 may be determining a restaurant in which to dine, the customer 202 therefore may search after purchase experience data for restaurants in an area, to aid in the selection of a restaurant. In other embodiments, the system may determine which product and/or merchant after purchase experience data to provide to the customer 202. For example, the system may recognize that a customer 202 is geo-localized within a merchant's place of business. Therefore, the system may provide the customer 202 with after purchase experience data for that merchant without the customer 202 requesting the data. The customer 202, with his/her request may filter data in any way that he/she may wish, such as, but not limited to geographic location, product type, merchant type, price, product specifications, and/or the like. In this way, the customer 202 may receive after purchase experience data tailored to his/her specific search criteria.

Once the system receives the customer's specific search criteria, the system may determine communications with a merchant that satisfy the customer's criteria in block 304. In this way, the system may search and pull after purchase experience data from several different directories such that the after purchase experience data may be compiled for the specific customer's search criteria. For example, a customer 202 may request to see after purchase experience data for all the Chinese food restaurants within a specific distant from the customer's current location. The system may determine all communications with Chinese restaurants within the specified distance from everyone whom has provided a mechanism for those Chinese restaurants. The system may then compile this data for the customer 202.

In some embodiments, as illustrated in decision block 306, the customer 202 may request the after purchase experience data in the aggregate form. If the customer 202 requests the data to be in aggregate form, the data may be provided to the customer 202 based on the customer's search criteria. Once the aggregate data is compiled by the system for the customer 202, the customer 202 may be provided the aggregate data in block 310. The customer 202 may receive the aggregate data via his/her customer system 204, email, text message, online banking, mobile applications, interfaces, voice messaging, mail, or the like from the after purchase experience system. The customer 202 may receive all compiled data relating to a merchant, a product, or a total customer experience at a merchant's place of business. The data received by the customer 202 may be in the form of graphs, charts, ratings, comments, overall performances, merchant product ratings, etc. that provides the customer 202 an indication as to other customers' reaction towards a merchant, the products a merchant sells, or the total purchase experience, such that the customer 202 may determine whether he/she would like to communicate with that merchant based on other customers after purchase experience data. In this way, the customer 202 may be able to review rich data from other customers who have communicated with the merchant or purchases a product recently, thus giving the customer 202 an indication as to other customers' satisfaction with the merchant, prior to the customer 202 communicating with the merchant. In some embodiments, the customer 202 may request aggregate form after purchase experience data. In other embodiments, the system may provide the customer 202 with the aggregate form after purchase experience data independent of a request for the data.

In some embodiments, as illustrated in decision block 308, the customer 202 may request the after purchase experience data to be in individual form. Once the individual form data is compiled by the system for the customer 202, the customer 202 may be provided the individual form data in block 312. If the data is distributed in individual form the customer 202 may receive his/her own prior after purchase experience. The customer 202 may receive individual form after purchase experience data via a customer system 204, email, text message, online banking, mobile applications, interfaces, voice messaging, mail, or the like from the after purchase experience system. In this way, the customer 202 may be provided with his/her own prior after purchase experience data, such that the customer 202 may recollect his/her prior experiences at a merchant or with a product. For example, the customer 202 may enter into a merchant and recognize the merchant's place of business. However, the customer 202 may not have visited the merchant for several years and may have forgotten about his/her prior experience with the merchant. Therefore, the customer 202 may be able to retrieve his/her prior after purchase experience data, such that he/she may recollect his/her prior experiences with the merchant. In some embodiments, the customer 202 may request individual form after purchase experience data. In other embodiments, the system may provide the customer 202 with the individual form after purchase experience data independent of a request for the data.

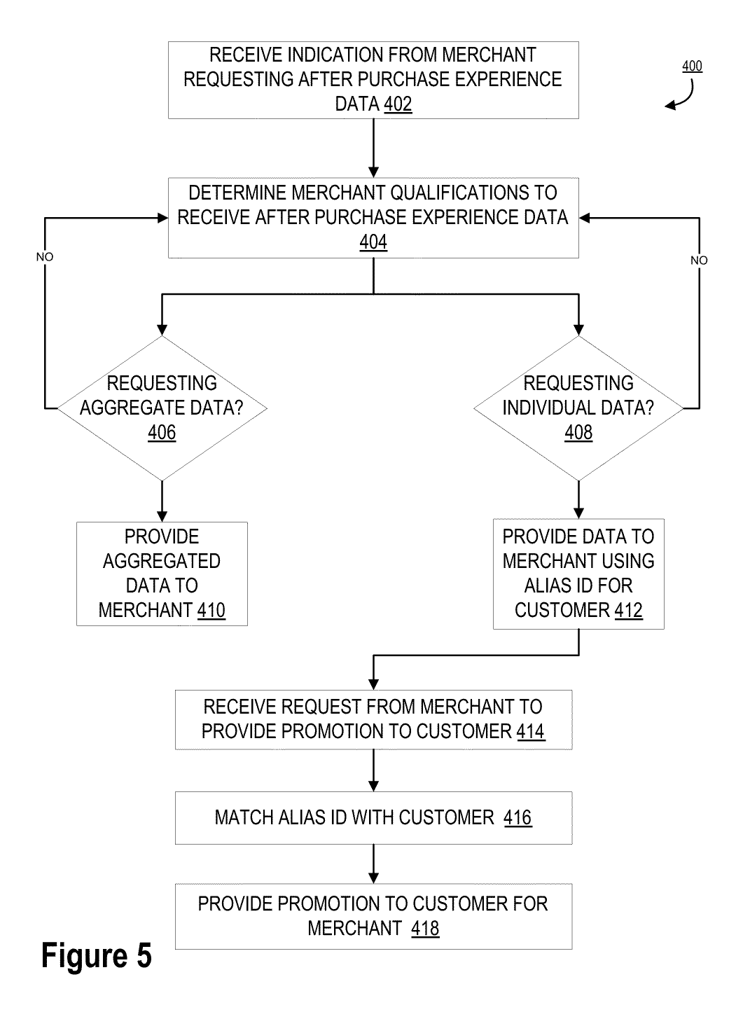

FIG. 5 illustrates a process map for a merchant request for after purchase experience data 400, in accordance with one embodiment of the present invention. In block 402 the system may receive an indication from a merchant requesting after purchase experience data. The indication the system may receive from the merchant requesting the after purchase experience data may, in some embodiments, be sent from a merchant via email, text message, online banking, mobile applications, interfaces, voice messaging, mail, using the merchant system 206, or the like. In other embodiments, the merchant may not provide a request for after purchase experience data in order to receive the data, but instead the system may provide the data to the merchant without a request. The request for after purchase experience data may comprise merchant filter criteria. This may include geographical location, merchant type (e.g., sporting goods store, grocery store, etc.), products sold at merchant, and/or the like.

Next, at block 404 the system may determine if the merchant qualifies to receive after purchase experience data. Qualifications for after purchase experience data may be determined by the financial institution providing the system. Qualifications may require the merchant providing payment prior to the distribution the after purchase experience data to the merchant. If the system determines that the merchant qualifies to receive after purchase experience data, the system may provide the merchant with the data based on the request from the merchant. The data may be distributed to the merchant in either an aggregate or individual form.

In decision block 406 the merchant may request the aggregate form of after purchase experience data. If the after purchase experience data is distributed in the aggregate form to the merchant, the merchant may receive all compiled data relating to the merchant, the products sold by the merchant, other merchants, or the total customer 202 experience at the merchant's place of business. At block 410, the system may provide the merchant with aggregated after purchase experience data. The data received by the merchant may be in the form of graphs, charts, ratings, comments, overall performances, merchant product ratings, etc. that provides the merchant an indication as to customers 202 reaction towards the merchant, the products the merchant sells, other merchants, or the total purchase experience, such that the merchant may receive feedback from actual customers 202 regarding the merchant's performance and the merchant's place of business. In this way, the merchant may be able to review rich data from customers 202 who have communicated with the merchant recently. This data may provide the merchant with an indication as to its performance, the satisfaction of its customers 202, product reviews, satisfaction of customers 202 at other merchants, and possible areas of improvement to provide a better experience for a customer 202.

In some embodiments, the merchant may request individual form data, as illustrated in decision block 408. If the data is distributed in individual form the merchant may receive after purchase experience data in the form of individual customer 202 responses. In other words, the merchant may receive the same data that the customer 202 provided in the mechanism for providing after purchase experience data. The merchant may receive all individual form data relating to the merchant, the products sold by the merchant, other merchants, or the total customer 202 experience at the merchant's place of business. At block 412, the system may provide the merchant with individual form after purchase experience data. The data received by the merchant may be in the form of graphs, charts, ratings, comments, overall performances, merchant product ratings, etc. that provides the merchant an indication as to customers 202 reaction towards the merchant, the products the merchant sells, other merchants, or the total purchase experience, such that the merchant may receive feedback from actual customers 202 regarding the merchant's performance and the merchant's place of business. The individual form data is distributed to the merchant with a customer 202 alias ID accompanying the data. In this way, the system may know the identity of the customer 202 that corresponds to the alias ID, but the merchant requesting the data may not. The merchant may receive the alias ID of the customer 202 as well as any ratings, comments, remarks, conclusions, or the like that the customer 202 may have provided via an after purchase experience mechanism. In this way, the merchant may be able to review, at an individual customer 202 level, rich data from customers 202 who have communicated with the merchant recently and determine how individual customer's rate the merchant's place of business, products, other merchants, or the total customer experience at the merchant. This data may provide the merchant with an indication as to its performance, the satisfaction of its customers 202, product reviews, and possible areas of improvement to provide a better experience for a customer 202.

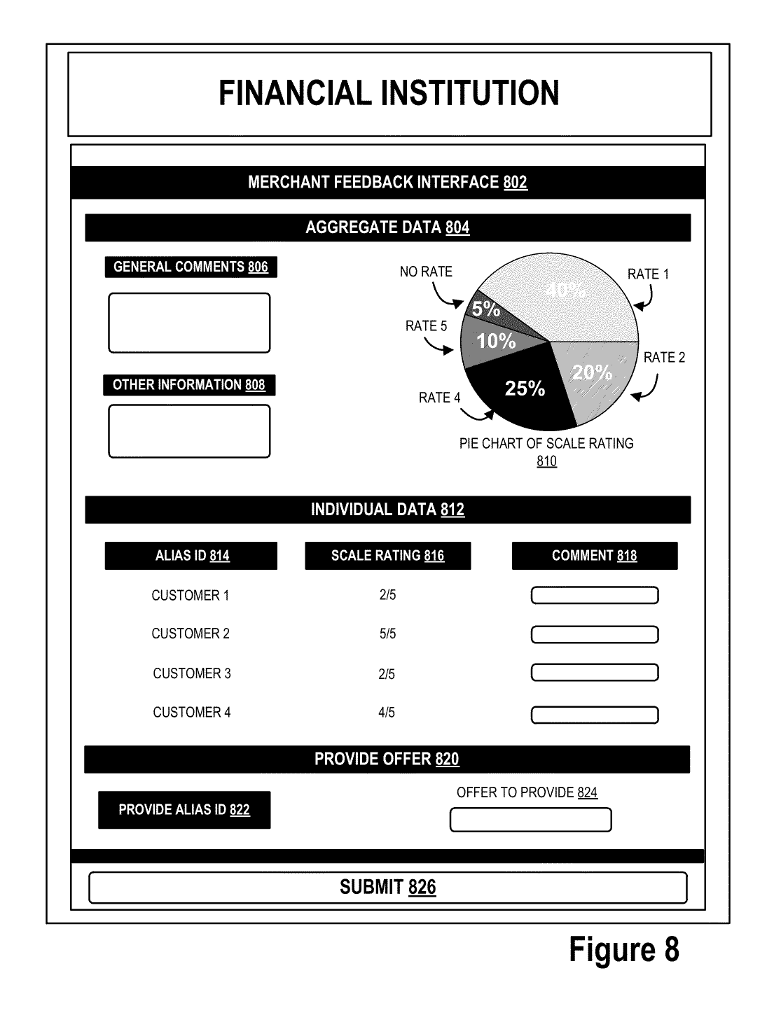

An example of after purchase experience data provided to a merchant is further illustrated in FIG. 8. FIG. 8 illustrates a merchant feedback interface 802, where a merchant has received both aggregate and individual after purchase experience data. As a person of ordinary skill in the art will appreciate, the data may be presented to a merchant in many embodiments. The embodiment illustrated in FIG. 8 is an example of the way the after purchase experience data may be presented to a merchant.

In some embodiments, merchants are provided only aggregate after purchase experience data. In some embodiments, merchants are provided only individual after purchase experience data. In yet other embodiments, merchants are provided both individual and aggregate after purchase experience data. In the embodiment illustrated in FIG. 8, the merchant is provided with both aggregate and individual after purchase experience data. In section 804 the merchant is provided with aggregate data 804. The aggregate data provided includes general comments 806. The general comments 806 include a general statement combining several individual customer 202 comments. The aggregate data section 804 also includes an other information section 808. The other information section 808 allows the system to provide the merchant with general statements that customers 202 may make that may not fit into the general comments 806 section. In the embodiment illustrated in FIG. 8, the merchant is also provided with a pie chart of scale ratings 810. The pie chart of scale ratings 810 illustrates the percentage of individuals who rated the merchant as a 1-5. For example, in the embodiment illustrated in FIG. 8, customers 202 rate the merchant with a 1, 40 percent of the time.

As illustrated in section 812, individual form data is provided to the merchant. At section 814 the alias ID of the customer 202 is listed. In this way, the merchant may identify a customer 202 by an alias ID such that the merchant may not know the customer's personal information. Next, at section 816, the scale rating of each customer 202 is provided. Finally, at section 818 the comments from each customer 202 are provided. For example, customer 2 rates the merchant a 5/5 and the customer's comments will be displayed under the comment section 818. If the merchant decides to offer customer 2 a promotional offer, the merchant is able to do that in the provide offer section 820. In the provide offer section 820, the merchant may provide the alias ID of the customer 202 in section 822 and also provide the offer the merchant wishes to provide to the customer 202 in section 824. Once the merchant is finished providing an offer or viewing the merchant feedback interface 802, the merchant may submit the offer by selecting the submit button 826.

Returning to FIG. 5, at block 414 the system may receive a request from a merchant to provide promotional offers to a customer 202. In this way, the merchant may provide the system with the alias ID for the customer 202 that the merchant requests the promotional offer be directed. Merchants may provide a customer 202 with promotional offers at its discretion. The merchant may provide offers to a customer 202 independent of the customer's 202 after purchase experience data or in view of the customer's after purchase experience data. Once the system receives the alias ID for the customer 202 that the merchant wishes to provide a promotional to the system may match the alias ID with a customer 202 in block 416. The matching of alias ID to a customer 202 provides the system with the customer's personal information, such that the financial institution may provide the customer 202 with an offer. Once the merchant provides the offer to the system, in block 418 the system may provide the customer 202 with a promotional offer from the merchant. In some embodiments, the offers may be sent to the customers 202 via a network, to the customer's customer system 204. In other embodiments, the offer may be sent to the customer 202 via text massage, voice message, standard mail, a mobile application, to an email address, to a social network site of the customer 202, and/or the like. A promotional offer that may be provided to the customer 202 may be in the form of a discount, rebate, coupon, etc. that may expire within a predetermined amount of time or may be available to the customer 202 at any time he/she wishes to make a transaction.

FIG. 6 illustrates a process map for after purchase experience data on the data share platform 500, in accordance with one embodiment of the present invention. At bock 502 the system may mine data from all after purchase experience data to determine data to be put on the data share platform. This mined data may be secondary to the data related to a customer's after purchase experience, but may prove to be useful data for financial institutions, other merchants, and other business entities. The mined data may be secondary to the merchant, product, or total purchase experience, but it may be extracted from the after purchase experience data received by the system. In some embodiments, the data share platform may include all data receive by the after purchase experience system, not just secondary data. This data may include, but is not limited to data for marketing purposes, geographic indication data, purchase habit data, etc. For example, in one specific geographical location, it may be determined that most of response to mechanisms to provide after purchase experience data from customers 202 for fuel provider merchants may indicate that customers 202 are generally purchasing groceries from a retail merchant instead of the grocery specific merchant. Many merchants may find this information useful for marketing, targeting, promoting, etc. Thus, the financial institution may be able to provide this type of data, received as part of the collection of after purchase experience data, to merchants to utilize. In another example, other divisions of the financial institution may utilize the after purchase experience data in a similar way. For example, the after purchase experience data may indicate that a customer 202 is always dissatisfied with his/her experiences. This data may be combined with other financial institution data to make a determination that the customer 202 may be a fraud risk. In yet another example, the after purchase experience data on the data share platform combined with other financial institution data may provide an indication to the financial institution that a raise in credit card limit or loan amount may be applicable to that customer 202.

The mined data is then stored on the data share platform in block 504. The mined data stored on the share platform may only be in the aggregate form, to ensure individual customer 202 personal identification security. The mined data stored on the data share platform may be accessed and shared with merchants, financial institutions, and other entities. In some embodiments, the data on the data share platform comprises all after purchase experience data the system receives. In other embodiments, the data on the data share platform is limited in the data which is accessible via the data share platform. At block 506, the system may receive a request to access data on the data share platform from a merchant, financial institution, or other entity. The request may be made by any individual or entity that may be interested in the rich data collected by the after purchase experience system.

Once a request is made, the system determines the requestor's qualifications to access the data share platform in block 508. In some embodiments the requestor may qualify by providing payment to the after purchase experience program for the data. In some embodiments, the requestor may qualify by indicating to the after purchase experience system the reason for the request for access to the data share platform. Once it is determined that the requestor is qualified to access the data share platform, the requestor may receive the data on the data share platform. In some embodiments, as illustrated in block 512 the system may provide data from the data share platform to the requestor based on the request from the requestor. For example, the requestor may request all data pertaining to what payment devices customers 202 used for retail shopping with a specific neighborhood. The system may retrieve this information from the data share platform and provide it to the requestor. In some embodiments, as illustrated in block 510 the requestor may be provided access to the data on the data share platform to search the data share platform for any data that he/she wishes to receive.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, etc.) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing after purchase experience information, the method comprising:
determining, via a computer device processor, that a customer communicated with a merchant, wherein the communication is an indication that the customer approached the merchant or approached a product of the merchant;
providing, based at least in part on the customer communication with the merchant, a mechanism that allows the customer to provide input data regarding the customer's communication with the merchant;
receiving the mechanism comprising customer input at a storage device;
compiling customer input data retrieved from the mechanisms in one or more directories;
receiving a request from a requestor to access the customer input data in the one or more directories; and
providing customer input data from the one or more directories to the requestor based at least in part on the request for access the customer input data.

2. The method of claim 1 further comprising associating an anonymous identification with the customer providing the customer input data.

3. The method of claim 1 wherein compiling customer input data retrieved from the mechanism in one or more directories further comprises compiling the anonymous identification of the customer with the customer data retrieved from the mechanism in the one or more directories.

4. The method of claim 2 wherein providing customer data from the one or more directories to the requestor further comprises distributing customer data from one customer to the requestor, wherein the customer data comprises the anonymous identification of the customer.

5. The method of claim 1 wherein providing data from the one or more directories to the requestor further comprises distributing aggregated data, wherein the aggregated data comprises data from multiple mechanisms in aggregate.

6. The method of claim 1 wherein determining that the customer communicated with the merchant further comprises a customer transaction at the merchant, wherein the transaction is determined by an authentication of the transaction.

7. The method of claim 1 wherein determining that the customer communicated with the merchant further comprises the customer visiting the merchant place of business.

8. The method of claim 1 further comprising distributing customer input data from the one or more directories to a data share platform.

9. The method of claim 8 wherein the data share platform comprises the customer input data from the one or more directories and secondary data determined from the customer input data retrieved from the mechanism.

10. The method of claim 8 wherein the data share platform is accessible and searchable by a qualified entity.

11. A system for providing after purchase experience information, the system comprising:
a memory device;
a communication device; and
a processing device operatively coupled to the memory device and the communication device, wherein the processing device is configured to execute computer-readable program code to:
determine that a customer communicated with a merchant, wherein the communication is an indication that the customer approached the merchant or approached a product of the merchant;
provide, based at least in part on the customer communication with the merchant, a mechanism that allows the customer to provide input data regarding the customer's communication with the merchant;
receive the mechanism comprising customer input at a storage device;
compile customer input data retrieved from the mechanisms in one or more directories;
receive a request from a requestor to access the customer input data in the one or more directories; and
provide customer input data from the one or more directories to the requestor based at least in part on the request for access the customer input data.

12. The system of claim 11 wherein the processing device is further configured to associate an anonymous identification with the customer providing the customer input data.

13. The system of claim 11 wherein the processing device is further configured to compile customer input data retrieved from the mechanism in one or more directories further comprises compiling the anonymous identification of the customer with the customer data retrieved from the mechanism in the one or more directories.

14. The system of claim 12 wherein the processing device is further configured to provide customer data from the one or more directories to the requestor further comprises distributing customer data from one customer to the requestor, wherein the customer data comprises the anonymous identification of the customer.

15. The system of claim 11 wherein providing data from the one or more directories to the requestor further comprises distributing aggregated data, wherein the aggregated data comprises data from multiple mechanisms in aggregate.

16. The system of claim 11 wherein determining that the customer communicated with the merchant further comprises a customer transaction at the merchant, wherein the transaction is determined by an authentication of the transaction.

17. The system of claim 11 wherein determining that the customer communicated with the merchant further comprises the customer visiting the merchant place of business.

18. The system of claim 11 wherein the processing device is further configured to distribute customer input data from the one or more directories to a data share platform.

19. The system of claim 18 wherein the data share platform comprises the customer input data from the one or more directories and secondary data determined from the customer input data retrieved from the mechanism.

20. The system of claim 18 wherein the data share platform is accessible and searchable by a qualified entity.

21. A computer program product, the computer program product comprising at least one non-transitory computer-readable medium having computer-readable program code portions embodied therein, the computer-readable program code portions comprising:
an executable portion configured for determining that a customer communicated with a merchant, wherein the communication is an indication that the customer approached the merchant or approached a product of the merchant;
an executable portion configured for providing, based at least in part on the customer communication with the merchant, a mechanism that allows the customer to provide input data regarding the customer's communication with the merchant;
an executable portion configured for receiving the mechanism comprising customer input at a storage device;
an executable portion configured for compiling customer input data retrieved from the mechanisms in one or more directories;
an executable portion configured for receiving a request from a requestor to access the customer input data in the one or more directories; and
an executable portion configured for providing customer input data from the one or more directories to the requestor based at least in part on the request for access the customer input data.

22. The computer program product of claim 21 further comprising associating an anonymous identification with the customer providing the customer input data.

23. The computer program product of claim 21 wherein compiling customer input data retrieved from the mechanism in one or more directories further comprises compiling the anonymous identification of the customer with the customer data retrieved from the mechanism in the one or more directories.

24. The computer program product of claim 22 wherein providing customer data from the one or more directories to the requestor further comprises distributing customer data from one customer to the requestor, wherein the customer data comprises the anonymous identification of the customer.

25. The computer program product of claim 21 wherein providing data from the one or more directories to the requestor further comprises distributing aggregated data, wherein the aggregated data comprises data from multiple mechanisms in aggregate.

26. The computer program product of claim 21 wherein determining that the customer communicated with the merchant further comprises a customer transaction at the merchant, wherein the transaction is determined by an authentication of the transaction.

27. The computer program product of claim 21 wherein determining that the customer communicated with the merchant further comprises the customer visiting the merchant place of business.

28. The computer program product of claim 21 further comprising distributing customer input data from the one or more directories to a data share platform.

29. The computer program product of claim 28 wherein the data share platform comprises the customer input data from the one or more directories and secondary data determined from the customer input data retrieved from the mechanism.

30. The computer program product of claim 28 wherein the data share platform is accessible and searchable by a qualified entity.
